(19) United States
(12) Patent Application Publication
(10) Pub. No.: US 2006/0248502 A1
(43) Pub. Date: Nov. 2, 2006

(54) Automated development method with update

(76) Inventors: Dominique Sueur, Versailles (FR); Madeleine Faugere, Epinay Sur Orge (FR)

Correspondence Address: LOWE HAUPTMAN GILMAN & BERNER, LLP, 1700 DIAGNOSTIC ROAD, SUITE 300, ALEXANDRIA, VA, 22314, US

(21) Appl. No.: 10/546,649

(22) PCT Filed: Feb. 18, 2004
(86) PCT No.: PCT/EP04/50151

§ 371 Date: Aug. 24, 2005

(30) Foreign Application Priority Data
Mar. 3, 2003 (FR) 03/02558

(51) Int. Cl. G06F 9/44

(52) U.S. Cl. 717/101

(57) ABSTRACT

The method in accordance with the invention is an automated development method with update, having several design steps, with transformation rules making it possible to go from one step to the next, and it is characterized in that at least one link of traceability with the element on the basis of which it emanated according to the transformation rule is associated with each model element produced automatically during design.

The present invention relates to a method of automated development with update.

The development of a complex system requires various steps of solving problems and of incremental design. The objective is to construct the specification of a solution complying with the specification of a problem. In the software field, the specification of a client requirement gives rise to the production of an analysis document, then of a design document and finishes with the production of the expected program. The analysis, design and production make it possible to construct a solution incrementally by explaining the construction path. These various steps facilitate the maintenance of the program which results from the various design steps and make it possible to upgrade the software thus produced as a function of the client's requirements.

Regardless of the field of application, it is possible to formalize, with appropriate languages, the construction steps and their results, which will hereinafter be called design levels. A design level may, for example, be expressed in the form of UML (Unified Modeling Language) models.

It is possible to partially generate a design level as a function of the design level which precedes it on the basis of transformation rules. New information must however be introduced manually to enhance the newly created model and refine the concepts so as to converge to the level of detail expected for the production of the solution.

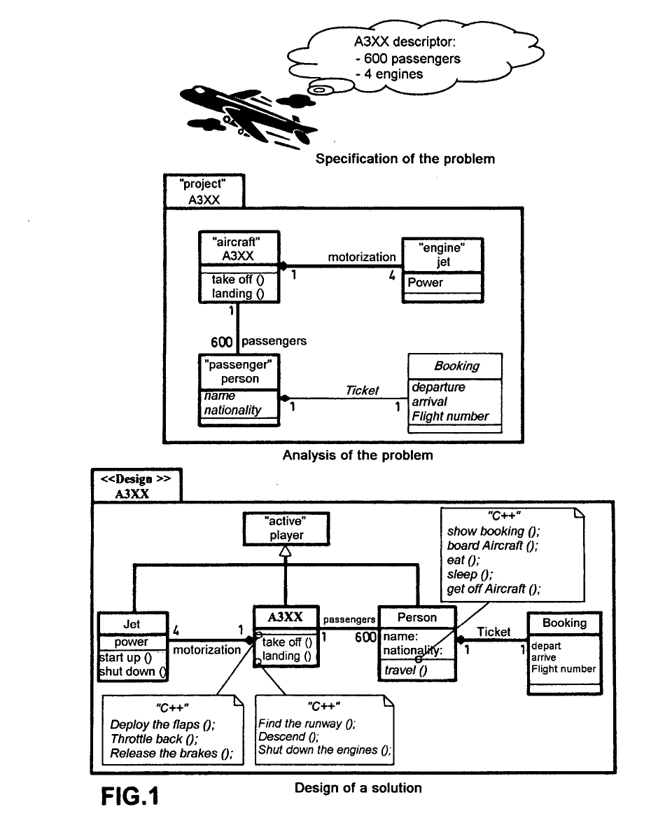

The incremental approach is illustrated with the aid of a very simplified example taken from the field of air traffic simulation, and shown diagrammatically in FIG. 1: First development. This figure comprises three design levels:
1. The first design level is called “specification of the problem”. It is at this level that the client defines his requirement: each aircraft is characterized by a name (A3XX), a number of passengers (600) and a number of engines (4).
2. The “analysis of the problem” level is produced in UML. This analysis step is again highly related to the field of the domain concerned. On completion of this step, the concepts of “aircraft”, of “passenger”, and of “engine” also appear (these items of information are denoted between quotation marks. These are the objects indicative of the design level considered). New information such as the booking, the name and the nationality of the passengers, etc also appears on account of this analysis step. These items of information refine concepts of the previous design level; they cannot be deduced automatically: they are the production choices of the designer.
3. The “design of a solution” level is much more “technical”. The language used is no longer related to the aerospace field. One is no longer concerned with the concepts of aircraft or of passengers. The emphasis is based on the concept of player (computer object triggering processing operations) which has to be simulated. It is at this level that the actions to be executed in a language close to that directly comprehensible to the computer (for example C++) are defined precisely.

In the FIG. 1: First development, all the elements shown with a fine line or in italic characters refer explicitly to the information added manually. All the information represented by a bold line or character is obtained automatically by applying the following transformation rules R₁ to R₉:
Creation of the “analysis of the problem” design level:
R₁: For any aircraft descriptor comprising a name, a number of passengers and a number of engines, the algorithm consists in:
   a. creating a stereotyped directory “project” in the name of the aircraft (name) comprising:
      i. a class stereotyped “aircraft” named “name” (name referring to the aircraft name),
      ii. a class stereotyped “engine” having as name “jet”,
      iii. a class stereotyped “passenger” having as name “person”.
   b. creating a relation (UML composition link) named “motorization” between the “aircraft” stereotyped class and the “engine” stereotyped class with as cardinalities (number/numeral) one “aircraft” stereotyped class side, value of number of engines “engine” stereotyped class side.
   c. creating an association link named “passenger” between the “aircraft” stereotyped class and the “passenger” stereotyped class with as cardinalities one aircraft side, value of number of passengers “passenger” stereotyped class side.
Creation of the “design of a solution” design level:
R₂: For any “project” stereotyped directory at the “analysis of the problem” level the algorithm consists in:
   a. creating a “design” stereotyped directory at the “design of a solution” level having the same name as the name of the “project” stereotyped directory of the “analysis of the problem” design level;
   b. creating an “active” stereotyped “player” class;
R₃: For any “aircraft” stereotyped class at the “analysis of the problem” level the algorithm consists in:
   a. creating a stereotypeless class at the “design of a solution” level having the same name as the name of the “aircraft” stereotyped class of the “analysis of the problem” design level;
   b. creating a inheritance relation going from the newly created class to the “active” stereotyped class;
R₄: for any “passenger” stereotyped class at the “analysis of the problem” level the algorithm consists in:
   a. creating a stereotypeless class at the “design of a solution” level having the same name as the name of the “passenger” stereotyped class of the “analysis of the problem” design level;
   b. creating an inheritance relation going from the newly created class to the “active” stereotyped class;
R₅: For any “engine” stereotyped class at the “analysis of the problem” level the algorithm consists in:
   a. creating a stereotypeless class at the “design of a solution” level having the same name as the name of the “engine” stereotyped class of the “analysis of the problem” design level;
   b. creating an inheritance relation going from the newly created class to the “active” stereotyped class;
R₆: For any nonstereotyped class at the “analysis of the problem” level the algorithm consists in:
   a. creating a stereotypeless class at the “design of a solution” level having the same name as the name of the class of the “analysis of the problem” design level;
R₇: for any association linking two classes A and B at the “analysis of the problem” level the algorithm consists in:
   a. creating an association at the “design of a solution” level linking the classes emanating from A and B by the transformation algorithm. The cardinalities (the numerals) and the role (the name) are identical to those of the “analysis of the problem” design level;
R₈: For any operation of a class A of the “analysis of the problem” level the algorithm consists in:
   a. creating an operation at the “design of a solution” level having the same name as the name of the operation of the “analysis of the problem” design level;
   b. associating this operation with the class emanating from A by the transformation algorithm.
R₉: For any attribution of a class A of the “analysis of the problem” level the algorithm consists in:
   a. creating an attribute at the “design of a solution” level having the same name as the name of the operation of the “analysis of the problem” design level;
   c. associating this attribute with the class emanating from A by the transformation algorithm.

The design of a complex system, such as set forth succinctly hereinabove, involves several design steps and may require numerous iterations. At each iteration, the designer reassesses his choices. He makes modifications to improve his models. Now, the mechanism of transformation rules makes no allowance for this aspect. Upon reapplication of the rules, allowance is made for the modifications from the point of view of the construction for the reconstruction of a level N+1 on the basis of the level N, but there is no integration of the modifications with the information already existing at a level N+1 created previously and completed manually. All the information that had been introduced manually is lost upon the reapplication of the rules.

The problem is to go automatically or semiautomatically from one design level N to a level N+1 (or more generally from one model to another) with the following constraints:
preserve the information added at the subjacent level N+1 upon reapplication of the rules;
preserve and make explicit all the information used upon the application of the rules so as to be able to reproduce the process (this information will be called the parameters of the rule). Saving thereof allows the reapplication of the rules without new interaction with the designer.
This preservation of information is not achieved with the known methods. It is essential in order to maintain and upgrade the design levels, and can only be done by coupling the transformation with traceability, this coupling forming the subject of the present invention, as detailed hereinbelow.

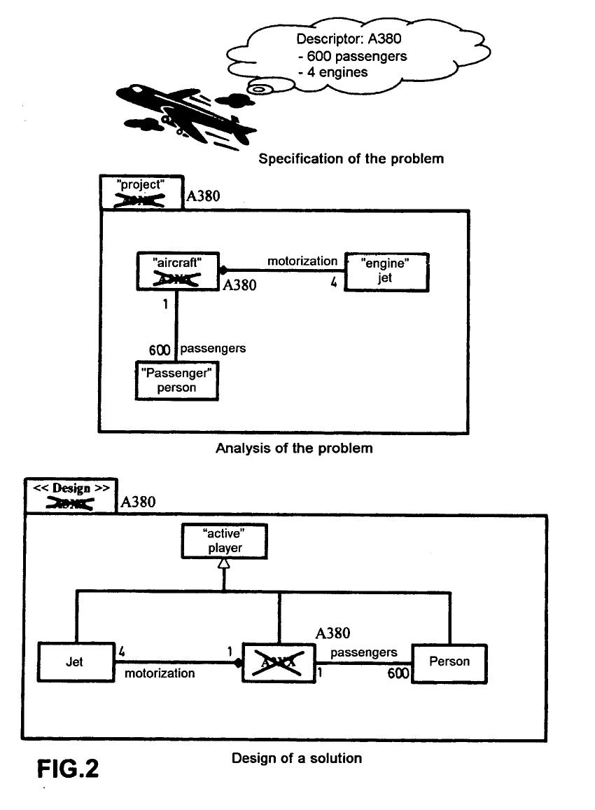

By way of example, to illustrate the principal drawback of the known methods, it is proposed to change the name of the aircraft A3XX to A380 at the “problem specification descriptor” level, the name A380 having been finally chosen, then to reapply the rules cited above. By applying just the known mechanism of transformation rules, we obtain the models presented in FIG. 2: non conservative transformation. All the occurrences of the name A3XX have been correctly replaced with A380 but all the information added manually (information in italics and in fine line on the various figures), during the first iteration, at the “analysis of the problem” and “design of a solution” level is lost. This solution is unacceptable: so as not to lose all his work, the designer must renounce the use of the transformation rules and manually pass on the modification (the name of the aircraft) to all the subjacent design levels, wherever necessary and with all the risks of inconsistencies that this represents. To do this work, the designer may, with the aid of the tools which exist, establish traceability elements for linking all the occurrences of the name A3XX. These links will enable him to locate all the modifications to be made upon the change of name, but these modifications will remain his responsibility. The transformation and traceability mechanisms are managed independently.

The subject of the present invention is a method of automated development coupling traceability and transformation.

The method in accordance with the invention is an automated development method with transformation rules making it possible to go from one model to another, with update, and it is characterized in that at least one link of traceability with the set of elements on the basis of which it emanated according to the transformation rule is associated with each automatically produced model element.

According to another feature of the invention, the elements manipulated are UML elements. Advantageously, a UML “dependency” is used to establish the traceability link, the “dependency” being such as defined at the OMG in the definition of the UML language.

According to yet another feature of the invention, the method of the invention is used to implement “design patterns”.

The present invention will be better understood on reading the detailed description of an embodiment, taken by way of nonlimiting example and illustrated by the appended drawing, in which:

FIG. 1, cited above, is a block diagram of a first development of an air traffic simulation program,

FIG. 2, likewise cited above, is a block diagram resulting from that of FIG. 1, as obtained after a nonconservative transformation, according to the prior art,

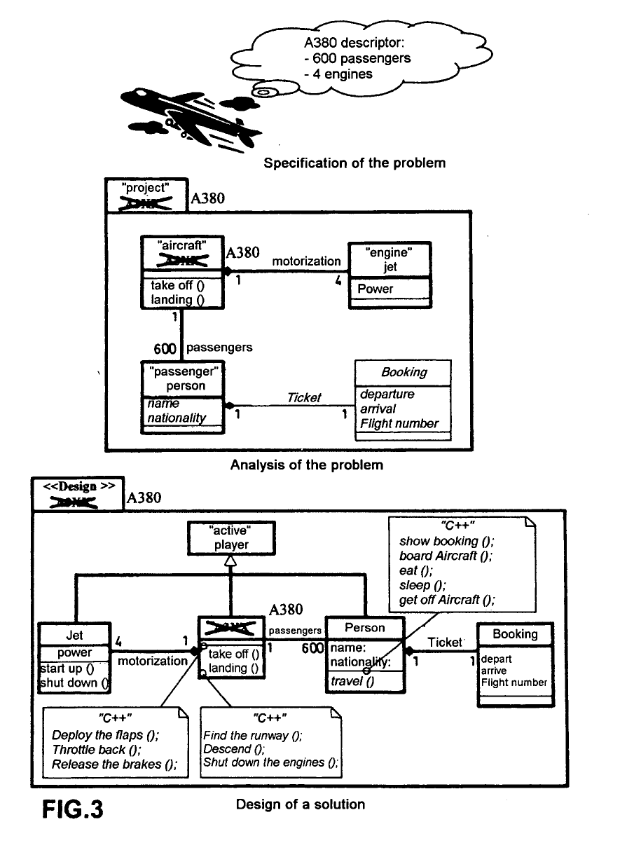

FIG. 3 is a block diagram resulting from that of FIG. 1, as obtained after a conservative transformation, according to the method of the invention,

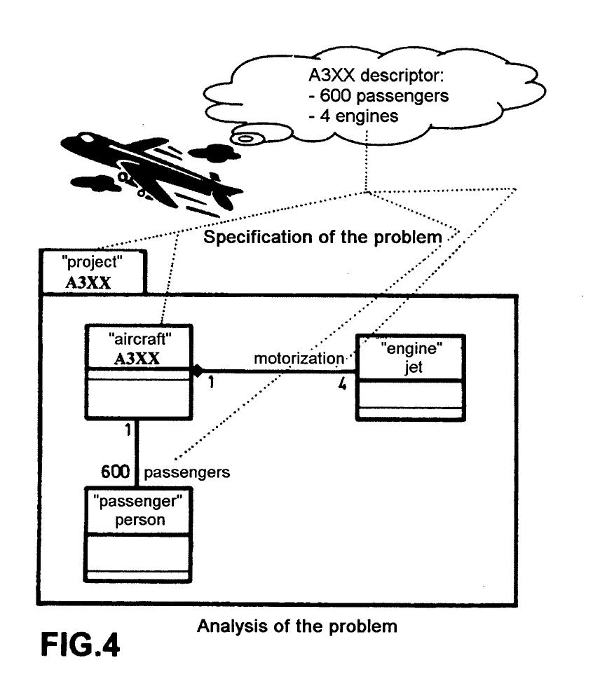

FIG. 4 is a block diagram illustrating the automatic construction of the analysis level according to the method of the invention (the dotted lines represent the traceability link which has been created),

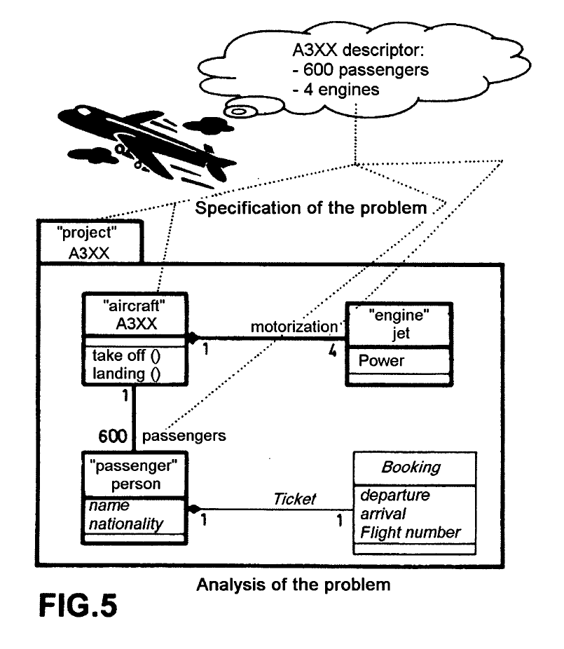

FIG. 5 is a block diagram illustrating the manual enhancement of the analysis level by the designer (information in italics and in a fine line).

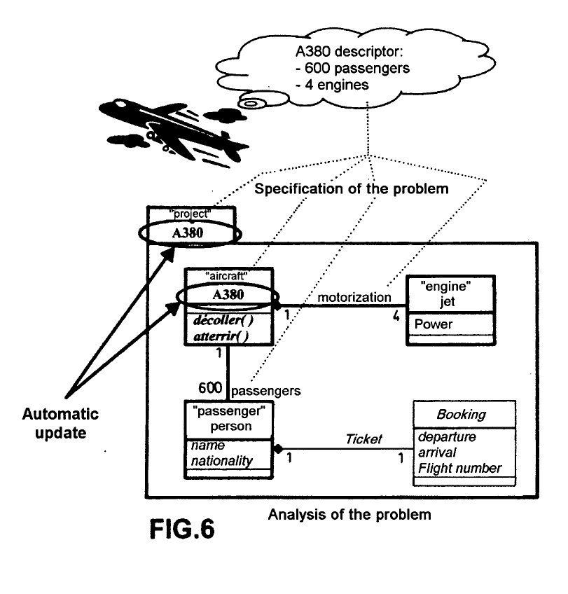

FIG. 6 is a block diagram illustrating the second iteration of the algorithm for implementing the method of the invention.

The designer has modified the specification of the problem by changing the name of the aircraft and has then reapplied the rules in order to update his model.

The invention proposes that traceability elements be associated with the transformation rules. The application of the transformation rules alone ensures only an ephemeral traceability link between elements of a source design level and the corresponding elements of the target design level. This link (source elements, target elements, and parameters of the rule) exists only during the application of the rule.

The invention proposes that a traceability mechanism be coupled with a transformation mechanism. To do this, the rules are supplemented with elements which:

make explicit the complete traceability between elements of a source design level to the various elements of a target design level,
make explicit the parameters of the rule (information provided by the designer necessary for applying the rules),
allow the updating of a target design level on the basis of a source design level with no impact on the elements not emanating from the application of a rule during an earlier transformation.

The conservative transformation mechanism of the invention makes it possible to maintain consistency in the design levels by applying rules coupled with traceability elements. With this mechanism, it is possible to rename the A3XX as A380 and to automatically pass this modification on to all the subjacent levels without losing the information added manually (cf. FIG. 3: Conservative transformation). The conservative transformation mechanism supports incremental and iterative development. It also supports endomorphic transformations (within a single design level). This mechanism may also serve to propagate marks serving to delete elements via rules similar to those of the example.

A mode of implementation of the method of the invention will now be described in detail.

The invention proposes a traceability mechanism coupled with the transformation rules, making it possible to render permanent the link between the elements produced by the transformation and the elements from which they emanated, as well as the information called parameters of the transformation rule. This link is called the traceability link. It is a logical link, which links n source elements to m target elements.

Definitions:

Let
R be a transformation rule
S be a set of element(s) of the source model (level N)
C be a set of elements of the target model (N+1), emanating from S, by application of the rule R,
PARAM_{S, R} be parameter of the rule R applied to S. The obtaining of these parameters may require dialog with the designer.
Link _{S,C,R} be the element of traceability between S, and C which may be associated with specific parameters (PARAM _{S, R}) pertaining to the application of R to S.

The algorithm for implementing the method of the invention comprises the following three parts:

Conservative transformation algorithm:

For any set S to which the rule R is applied
If Link _{S,C,R} exists then

Update C and the Link_{S,C,R}

Else

Create C, the Link _{S,C,R} and PARAM_{S, R}

Update the Cs, and the Link_{S,C,R}
The set C is obtained by following the Link _{S,C,R} emanating from
S. For any element of C, we assign the values calculated on the
basis of S, of R and possibly of PARAM_{S, R}.
Create C, the link _{S,C,R} and PARAM_{S, R}:
Creation then assignment (i.e. fixing of the values) of the
elements C by applying R and also creation of the link _{S,C,R} and
of the parameters PARAM_{S, R} (possibly empty).

The application of the algorithm of the method of the invention to the aforesaid example of the simulation of air traffic will now be described solely in respect of the “analysis of the problem” level. The next level, not described here for the sake of simplification, is obtained in a similar manner.

The first phase is the creation of the analysis model through a first iteration of the algorithm (cf. FIG. 4)

1st Application of the “Specification of the Problem” Rule R₁
Let:
   S be the “aircraft descriptor”: this is the set of source elements representing an aircraft descriptor comprising a name, a number of passengers and a number of engines.
   R be the creation rule R1 of the “analysis of the problem” design level.
There is no link emanating from S, it is therefore necessary to create the target elements, the Link _{S,C,R} and the associated parameters. We proceed in the following manner:
   On the basis of the aircraft descriptor comprising the name A3XX, a number of passengers of 600 and a number of engines of 4, the algorithm consists in:
   a. creating a “project” stereotyped directory bearing the name of the aircraft of the descriptor (i.e. A3XX) comprising:
      i. a class stereotyped “aircraft” named A3XX,
      ii. a class stereotyped “engine” having as name “jet”,
         iii. a class stereotyped “passenger” having as name “person”.
   b. creating a composition link named “motorization” between the “aircraft” stereotyped class and the “engine” stereotyped class with a cardinality 1 “aircraft” stereotyped class side, and 4 “engine” stereotyped class side.
   c. creating an association link named “passenger” between the “aircraft” stereotype class and the “passenger” stereotyped class with a cardinality 1 “aircraft” stereotyped class side, 600 “passenger” stereotyped class side.
   Creating the traceability link Link _{S,C,R} (with S=“aircraft descriptor”, C=“project” stereotyped A3XX directory, A3XX class, jet class, person class, the composition link and the association link that were previously created with their respective cardinalities and R=R₁).
   There are no parameters to the rule R (the designer does not make any choice explicit, since the rule needs no external information);

It is now assumed that the designer carries out the refinement of the analysis model (FIG. 5: Manual refinement of the analysis): He adds two procedures “landing” and “take off” to the class named A3XX
he adds a “power” attribute to the class named Jet
he adds two attributes “name” and “nationality” to the class named Person
he adds a “booking” class comprising three attributes “departure”, “arrival” and “flight number”
he adds a composition link between the Passenger class and the Booking class of cardinality 1.
   It is thereafter assumed that the designer carries out the modification of an item of information of the “specification of the problem” level:
he replaces the name A3XX with A380.

The way in which the method of the invention carries out the updating of the models, during a second iteration of the algorithm, will now be set forth. The result of the update is illustrated (FIG. 6: Modification of the specification and automatic update):

2nd Application of the “Specification of the Problem” Rule R₁:
Let:
   S be the “aircraft descriptor”: this is a source element representing an aircraft descriptor comprising a name, a number of passengers and a number of engines.
   R be the creation rule R1 of the “analysis of the problem” design level.

There exists a Link_{S,C,R} emanating from S. It is therefore necessary to call the subroutine Update C, the Link_{S,C,R} on the basis of the existing Link_{S,C,R}. The algorithm consists in:
1. Inputting at the analysis level the “project” directory related to the aircraft descriptor and updating it if necessary according to the characteristics of S via R; updating the Link S,C,R: the directory A3XX is renamed A380
2. Inputting at the analysis level the “aircraft” stereotyped class related to the aircraft descriptor and updating it if necessary according to the characteristics of S via R; updating the Link S,C,R: the class A3XX is renamed A380
3. Inputting at the analysis level the composition link named “motorization” related to the aircraft descriptor and updating it the cardinalities if necessary according to the characteristics of S via R; updating the LinkS,Cn: the cardinalities remain unchanged
4. Inputting at the analysis level the association link named “passenger” related to the aircraft descriptor and updating it the cardinalities if necessary according to the characteristics of S via R; updating the Link S,C,R: the cardinalities remain unchanged.

1. An automated development method with transformation rules making it possible to go from one model to another, with update, according to which the specification of a solution complying with the specification of a problem is constructed by producing an analysis document, then a design document, and finally by producing the program resulting from the design steps, comprising the steps of: associating at least one link of traceability with the set of elements on the basis of which it emanated according to the transformation rule with each automatically produced model element, this traceability link being intended to make allowance for the new information introduced manually during development.

2. The method as claimed in claim 1, wherein the elements manipulated are UML elements.

3. The method as claimed in claim 2, wherein a UML dependency is used to establish the traceability link.

4. The method as claimed in claim 2, wherein it is used to implement design patterns.
